(19) United States
(12) Patent Application Publication
(10) Pub. No.: US 2002/0184079 A1
(43) Pub. Date: Dec. 5, 2002

(54) Apparatus and method of mediating collection through communication with terminals storing identification information

(75) Inventor: Hajime Nishimoto, Hyogo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Mitsubishi Denki Kabushiki Kaisha, Tokyo (JP)

(21) Appl. No.: 09/977,414

(22) Filed: Oct. 16, 2001

(30) Foreign Application Priority Data
May 29, 2001 (JP) 2001-160994

(51) Int. Cl. G06F 17/60

(52) U.S. Cl. 705/10

(57) ABSTRACT

A mobile telephone stores unrewritable identification data for identifying its own hardware. When a user enters an answer to a questionnaire into a mobile telephone, the mobile telephone reads out the identification data, and sends the identification data and response data to a server. A method of mediating questionnairing includes the steps of prestoring a name and an address of the user corresponding to the identification data, sending a questionnaire to the mobile telephone, retrieving the name and address of the user based on the identification data received from the mobile telephone, and sending the name and address of the user and response data to a computer of a requester of the questionnairing.

### BACKGROUND OF THE INVENTION

1. Field of the Invention

The present invention relates to a technology for questionnairing via a communication line, and particularly relates to a technology for reducing an operation load on respondents.

2. Description of the Background Art

The Internet has been developed in recent years, and can now be used in a questionnairing system. In this system, terminals of users are connected to a server over the Internet. The server sends questionnaires to the terminals. The user enters his/her name, address, gender, age and others as well as an answer into the terminal for sending them to the server. The server compiles the plurality of received answers for respective age ranges. Questionnairing is conducted as described above.

In the questionnairing system described above, the user must enter via a terminal the personal information, which includes the user's name, address, gender, age and others, and is used for personal identification. It may be envisaged to store in advance the personal information such as user's name, address, gender and age in a memory of the terminal for saving the labor of entry. However, items to be entered may be different depending on the questionnaires. The user must enter the personal information every time the user submits the response.

In the case where the terminal of user is a mobile telephone connected to the Internet, it is difficult to enter the personal information for every response due to limitations by keys on the mobile telephone. Further, the information such as name and address, which can be used for personal identification, should not be easily transferred to another person in view of privacy protection.

### SUMMARY OF THE INVENTION

An object of the invention is to provide apparatus and method of mediating collection, which allow easy collection of respondents in accordance with a request for collection by a requester.

Another object of the invention is to provide apparatus and method of mediating collection, which allow easy collection of respondents from a group specified by a requester of the collection.

Still another object of the invention is to provide apparatus and method of mediating collection, by which a respondent can easily submit an answer to a questionnaire and can easily apply for lottery.

Yet another object of the invention is to provide apparatus and method of mediating collection, which allow collection of responses to questionnaires while protecting privacy.

Further another object of the invention is to provide apparatus and method of mediating collection, which can improve the rate of application for the collection.

Further another object of the invention is to provide apparatus and method of mediating collection, which can improve the rate of application for the collection, while protecting the privacy.

An apparatus according to the invention for mediating collection of the users in accordance with a request of a requester of the collection includes a communication circuit for communicating with terminals via a network, a storage circuit for storing, in advance, collection information representing the collection, a collection sending circuit connected to the communication circuit and the storage circuit for sending the collection information to terminals of possible users, a user information storage circuit for storing, in advance, identification information and user information corresponding to the identification information, an application receiving circuit connected to the communication circuit for receiving the application information and the identification information from the user's terminals, a retrieval circuit connected to the application receiving circuit and the user information storage circuit for retrieving the user information stored corresponding to the received identification information, and an application sending circuit connected to the communication circuit and the retrieval circuit for sending the user information retrieved by the retrieval circuit and the application information to the terminal of the requester.

The user's terminal stores the unrewritable identification information for specifying the terminal itself of the user. This identification information is written in an electronic manner by a special device of a manufacturer of the user's terminal during manufacturing of the user's terminal. Once manufacturing of the user's terminal is completed, the identification information described above is extremely difficult for the manufacturer to rewrite. For third parties not having the special device other than the manufacturer, it is impossible to rewrite the identification information described above. The information described above includes information, which is extremely difficult to rewrite for the manufacturer, as well as information, which does not allow rewriting by the third parties other than the manufacturer.

When the user enters the application information for applying for the collection into the user's terminal, the terminal reads out the identification information, and sends the application information and the identification information to the apparatus. The apparatus sends the user information retrieved by the retrieval circuit and the application information. Thereby, the user is merely required to enter the answer to the questionnaire into the user's terminal, and is not required to enter the name, address and others of the user. The application information is sent to the terminal of the requester of collection. As a result, it is possible to provide the apparatus, which allows the respondent to submit the answer to the questionnaire and others without difficulty. The collection of the users specifically includes the collection of answers to the questionnaire conducted on the users, the collection of user's opinions on a certain subject and the collection of users applying for a prize competition or lottery. The application by the user specifically includes, e.g., the user's actions of submitting an answer to a questionnaire, submitting the user's opinion and applying for the prize competition.

More preferably, the apparatus further includes a collection target receiving circuit connected to the communication circuit for receiving information representing the collection target users determined corresponding to the user information from the terminal of the requester, and a collection target retrieval circuit connected to the user's information storage circuit and the collection target receiving circuit for retrieving the users matching with the collection target users based on the information representing the collection target user and the user information. The collection sending circuit includes a circuit for sending the collection information to the terminal of the user retrieved by the collection target retrieval circuit.

According to this invention, the range of target users to be collected can be narrowed based on the requester's designation. Therefore, the apparatus can perform the collection of users in the manner satisfying the requester.

More preferably, the user information includes personal information representing a name and an address of the user. The application sending circuit includes a circuit for sending the user information to the terminal of the requester in a manner preventing determination of the personal information by the requester.

When the questionnairing is performed, only the answer to the questionnaire is sent to the terminal of the requester, and the requester >cannot determine the personal information included in the user information. This prevents easy transfer of the personal information, which includes the name and address, and should be highly protected. As a result, the invention can provide the apparatus for mediating collection, which can protect the privacy.

More preferably, the apparatus further includes a lottery circuit for selecting a winner from the applicants based on the user information, and a personal information sending circuit connected to the communication circuit and the lottery circuit for sending the personal information of the winner to a terminal of a shipping agent delivering a prize to the winner so as to allow determination of the personal information by the shipping agent.

The collection mediating apparatus sends the personal information of the winner to the shipping agent so that the shipping agent can determine the personal information including the name and address. The shipping agent delivers the prize to the winner. When the user responds to the questionnaire or the like, the prize may be awarded to the user by the lottery. The user expects to get the prize, and responds to the questionnaire or the like. A rate of response to the questionnaire can be improved. Thereby, the invention can provide the apparatus for mediating collection, which can increase the respondents while protecting the privacy.

More preferably, the apparatus includes an inquiry receiving circuit connected to the communication circuit for receiving the user information of the winner from a terminal of the shipping agent, and a personal information sending circuit connected to the communication circuit for sending the personal information of the winner to the terminal of the shipping agent so as to allow determination of the personal information by the shipping agent.

The terminal of the requester selects the winner from the respondents to the questionnaire based on the user information such as identification codes formed of numbers. The terminal of the requester sends the user information of the winner to the terminal of the shipping agent delivering the prize to the winner. The shipping agent cannot determine the personal information of the winner based on the received user information. The shipping agent makes an inquiry to the collection mediating apparatus about the personal information of the winner based on the user information of the winner received from the terminal of the requester. The apparatus sends the personal information to the terminal of the shipping agent so as to allow determination of the personal information including the name and address. The shipping agent delivers the prize to the winner. By responding to the questionnaire, the prize may be awarded to the user by the lottery. The user expects to get the prize, and responds to the questionnaire or the like. The rate of response to the questionnaire can be improved. Thereby, the invention can provide the apparatus for mediating collection, which can improve the rate of response to the questionnaire while protecting the privacy.

According to another aspect, the invention provides a method for mediating collection of users in accordance with a request of a requester of the collection. The collection mediating method includes the steps of preparing collection information representing the collection, sending the collection information to terminals of the users, preparing identification information and user information corresponding to the identification information, receiving the application information and the identification information from the user's terminal, retrieving the user information stored corresponding to the received identification information, and sending the user information retrieved in the step of retrieving the user information and the application information to a terminal of the requester.

The user's terminal stores the unrewritable identification information for specifying the terminal itself of the user. When the user enters the application information for applying for the collection into the user's terminal, the terminal reads out the identification information, and sends the application information and the identification information. The collection mediating method sends the user information retrieved in the retrieving step and the application information to the terminal of the requester. Thereby, the user is merely required to enter the answer to a questionnaire into the user's terminal, and is not required to enter the name, address and others of the user. The application information is sent the terminal of the requester of the collection. As a result, the invention can provide the method, which allows the respondent to send the answer and others to the questionnaire without difficulty.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows whole structure of a questionnairing system according to a first embodiment of the invention;

FIG. 2 shows an appearance of a computer implementing a server;

FIG. 3 is a control block diagram of a computer;

FIG. 4 is a control block diagram of a mobile telephone;

FIG. 5 shows a user database stored on a fixed disk of the server according to the first embodiment;

FIG. 6 shows a questionnaire database stored on the fixed disk of the server according to the first embodiment;

FIG. 7 shows a response database stored on the fixed disk of the server according to the first embodiment;

FIG. 8 shows questionnaire data sent from a computer of a research agent to the server according to the first embodiment;

FIG. 9 shows user questionnaire data sent from the server to the mobile telephone according to the first embodiment;

FIG. 10 shows user response data sent from the mobile telephone to the server according to the first embodiment;

FIG. 11 shows server response data sent from the server to the computer of the research agent according to the first embodiment;

FIG. 12 is a flowchart showing processing in the questionnairing system according to the first embodiment;

FIG. 13 shows server response data sent from the server to the computer of the research agent according to the first embodiment;

FIG. 14 shows the questionnaire data sent from a computer of the research agent to the server according to a second embodiment of the first embodiment;

FIG. 15 is a flowchart showing processing in the questionnairing system according to the second modification of the first embodiment;

FIG. 16 shows the questionnaire database stored on the fixed disk of the server according to the second modification of the first embodiment;

FIG. 17 shows whole structure of a questionnairing system according to a second embodiment of the invention;

FIG. 18 shows the questionnaire database stored on the fixed disk of the server according to the second embodiment;

FIG. 19 shows the questionnaire data sent from the computer of the research agent to the server according to the second embodiment;

FIG. 20 shows winner notification data sent from the server to the computer of the shipping agent according to the second embodiment;

FIG. 21 is a flowchart showing processing in the server according to the second embodiment;

FIG. 22 shows the winner notification data sent from the computer of the research agent to the computer of the shipping agent according to the second embodiment;

FIG. 23 shows the inquiry data sent from the computer of the shipping agent to the server according to a modification of the second embodiment of the invention;

FIG. 24 shows response data sent from the server to the computer of the shipping agent according to the modification of the second embodiment; and

FIG. 25 is a flowchart showing processing in the questionnairing system according to the modification of the second embodiment.

### DESCRIPTION OF THE PREFERRED EMBODIMENTS

Embodiments of the invention will now be described with reference to the drawings. In the following description and drawings, the same parts bear the same reference numbers. The same parts bear the same names, and achieve the same functions. Therefore, description thereof is not repeated where appropriate.

First Embodiment

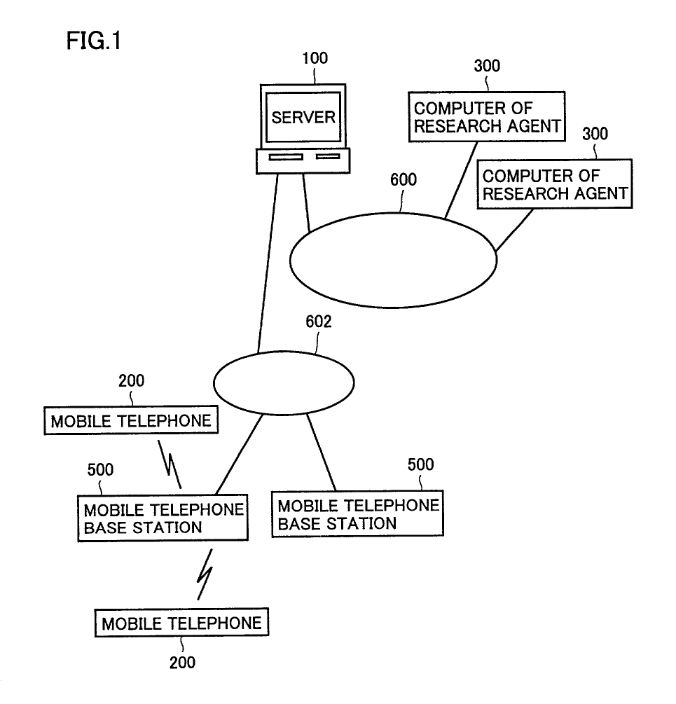

Referring to FIG. 1, a questionnairing system according to a first embodiment includes mobile telephones 200 of users responding to a questionnaire, a computer 300 of a research agent requesting the questionnairing to server 100, base stations 500 of mobile telephones 200 and server 100 connected to computer 300 of the research agent over a network 600. Server 100 is connected to base stations 500 of the mobile telephones over a network 602.

The user enters an answer to a questionnaire into his/her mobile telephone 200 of a subscriber line, for which the user signed with a communication company of the mobile telephone. Mobile telephone 200 has stored identification information for specifying the hardware itself of the mobile telephone. Mobile telephone 200 sends the user response data including the identification information to server 100 via base station 500. Based on the received identification information, server 100 retrieves the name and address of the user of mobile telephone 200 from the user database already stored therein. The name and address were provided by the user to the communication company when the user signed a contract for the subscriber line with the communication company of the mobile telephone. Server 100 prepares user response information, which includes the retrieved address and name as well as the answer. Server 100 sends the server response data to computer 300 of the research agent. As described above, server 100 implements a questionnairing mediating function for sending the server response data, which includes the name, address and others of the user as well as the answer, to the research agent based on the information received from mobile telephone 200 of the user.

As already described, the function of mediating the questionnairing is an example of the function of mediating the collection or invitation of users. The function of mediating the collection of users includes the foregoing function of mediating the questionnairing, and further includes the function of mediating the collection of user's opinions on a certain subject and the function of mediating the application for a certain prize or lottery. This embodiment is described in connection with the questionnairing mediating function. However, the function of mediating the collection of users according to the invention is not restricted to this.

In the questionnairing system of this embodiment, the questionnairing mediating function of server 100 is achieved by executing a predetermined program by a CPU (Central Processing Unit) in the computer.

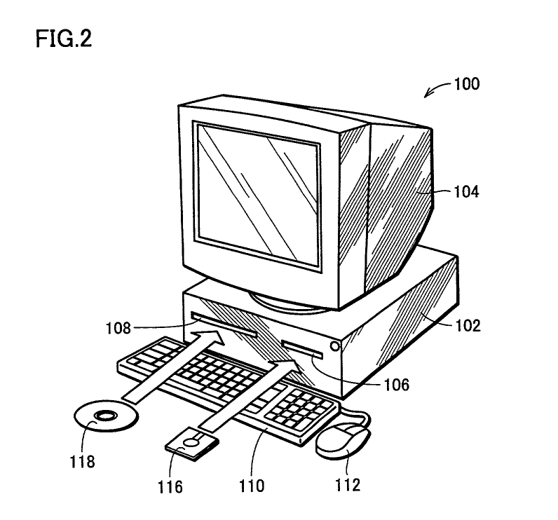

FIG. 2 shows an appearance of a computer system, which is an example of server 100 achieving the questionnairing mediating function. Referring to FIG. 2, the computer system includes a computer 102 provided with an FD (Flexible Disk) drive unit 106 and a CD-ROM (Compact Disc Read-Only Memory) drive unit 108, a monitor 104, a keyboard 110 and a mouse 112.

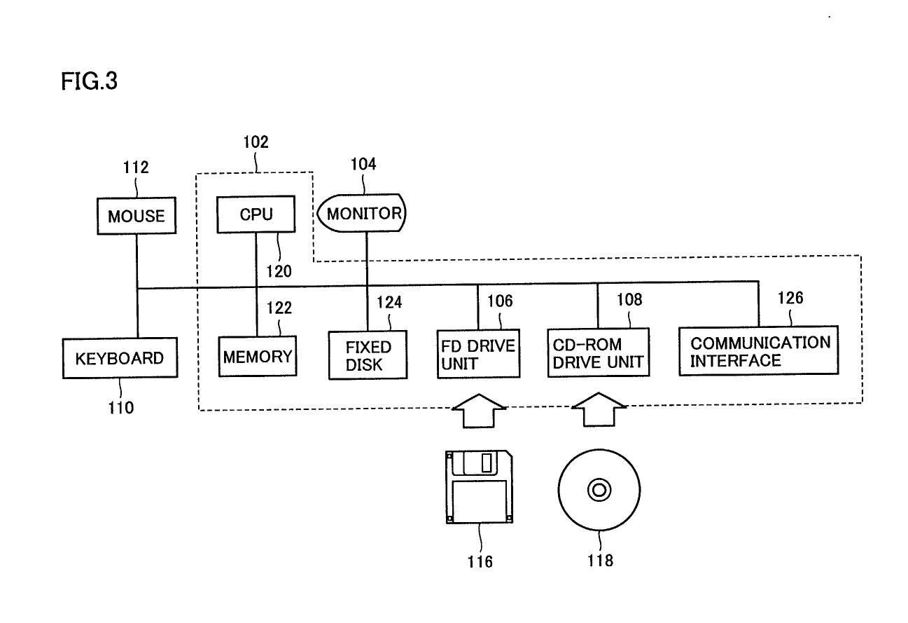

FIG. 3 is a block diagram showing architecture of the computer system. As shown in FIG. 3, computer 102 includes, in addition to FD drive unit 106 and CD-ROM drive unit 108, a CPU (Central Processing Unit) 120, a memory 122, a fixed disk 124 and a communication interface 126 for communication with other computers as well as a bus for mutually connecting these portions. An FD 116 is set in FD drive unit 106. A CD-ROM is set in CD-ROM drive unit 108. These FD 116 and CD-ROM 118 have stored predetermined programs.

As already described, server 100 having the questionnairing mediating function is achieved by the computer hardware and the software executed by CPU 120. In general, the above software has been stored as programs on the record mediums such as FD 116 and CD-ROM 118 for distribution, and is read from the record medium by FD drive unit 106 or CD-ROM drive unit 108 for storage in fixed disk 124. Further, the program is read from fixed disk 124 into memory 122, and is executed by CPU 120.

The hardware itself of the computer is common and well known. The computer includes a control circuit including the CPU, a storage circuit, an input circuit, an output circuit and an OS (Operating System), and thus satisfies system requirements for executing the program. In the invention, the program implements the questionnairing mediating function.

The operation itself of the computer shown in FIGS. 2 and 3 is well known, and therefore will not be described here.

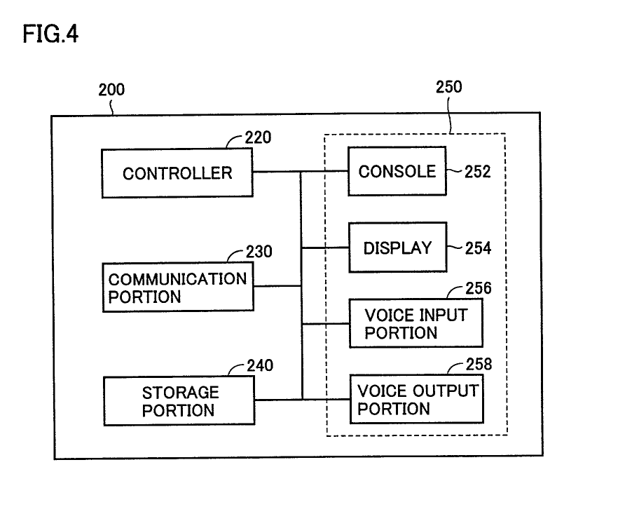

Referring to FIG. 4, user's mobile telephone 200 includes a controller 220 for controlling the whole of mobile telephone 200, a communication portion 230 for communication with other telephone sets and computers, a storage portion 240 for storing a program to be executed by controller 220, intermediate data produced by execution of the program and electronic mails received via communication portion 230, and an I/O portion 250.

I/O portion 250 includes an operation pad 252 including a ten-key pad, a display 254 including an LCD (Liquid Crystal Display) for displaying the telephone number entered through an operation pad 252 as well as a received questionnaire and an entered answer, a voice input portion 256 formed of a microphone for inputting voice and a voice output portion 258 formed of a loudspeaker outputting voice. Through an operation pad 252, the user of mobile telephone 200 can enter the telephone number of another telephone set, a request for displaying the received questionnaire, the answer to the questionnaire and a request for sending the entered answer.

Mobile telephone 200 stores in storage portion 240 the identification information for discriminating the hardware itself of mobile telephone 200 from other hardware. This identification information was stored during manufacturing of mobile telephone 200, and is unrewritable.

The user of mobile telephone 200 has already signed a contract for a subscriber line with the communication company of the mobile telephone. The user provides personal information including the user's name and address to the communication company of the mobile telephone. When signing the contract, the communication company of the mobile telephone defines a correspondence of the identification information of the mobile telephone and the telephone number of the mobile telephone with respect to the personal information. After signing the contract, the user can use mobile telephone 200.

Server 100 is managed by the communication company of the mobile telephone, with which the user signed for the line. As will be described later, server 100 uses the personal information, which is stored corresponding to the identification information.

In the following description, the user's terminal will be described as the mobile telephone, although not restricted thereto. The user's terminal may be a desk telephone or the like.

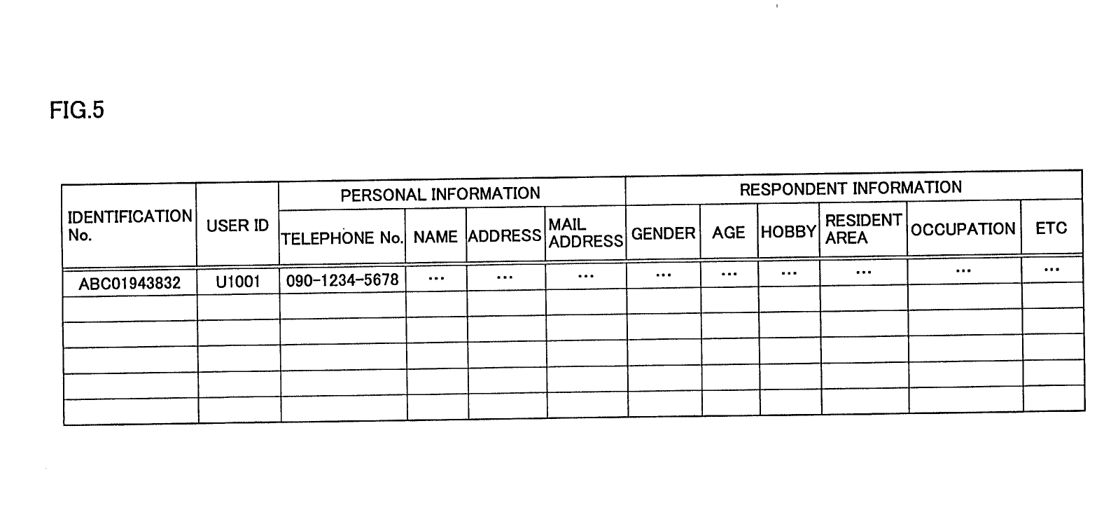

Referring to FIG. 5, description will be given on the user database, which is stored on fixed disk 124 of server 100 according to this embodiment. As shown in FIG. 5, the user database contains, for each identification number, the user ID (Identification), personal information and respondent information. The identification number corresponds to the identification information. The personal information includes the mobile telephone number, name, address and mail address of the user. The respondent information includes the gender, age, hobby, resident area, occupation and other information of the user. The user ID is the information applied from server 100 for specifying the user in this questionnairing system. The personal information should not be disclosed easily to the others in view of privacy protection.

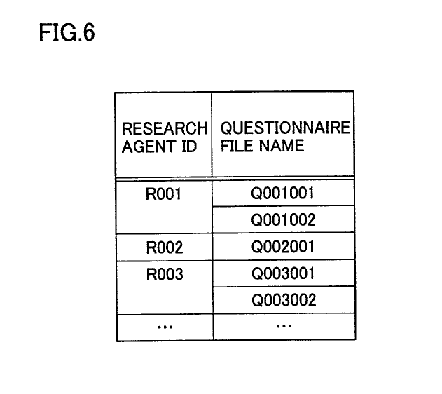

Referring to FIG. 6, description will now be given on the questionnaire database stored on fixed disk 124 of server 100. As shown in FIG. 6, the questionnaire database includes a questionnairing file name for each research agent ID. Server 100 receives questionnairing file storing the questionnaire data from computer 300 of the research agent.

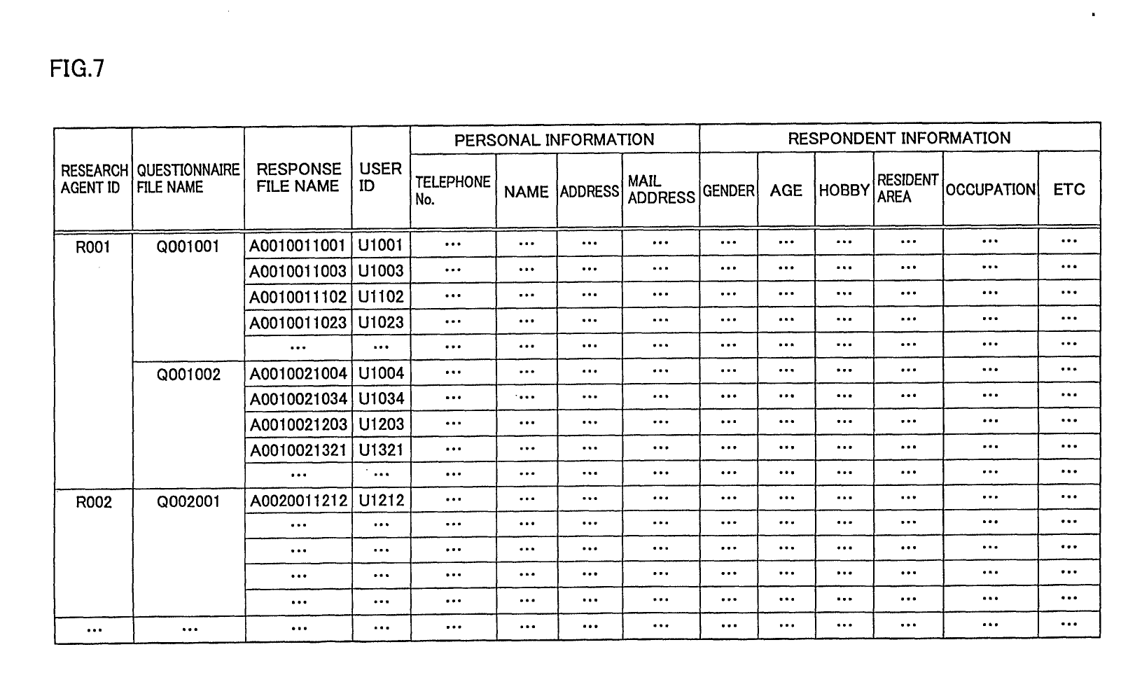

Referring to FIG. 7, description will now be given on the response database stored on fixed disk 124 of server 100. As shown in FIG. 7, the response database includes, for each research agent ID, the questionnaire file name, response file name, personal information of the user specified by the research agent ID and the respondent information. The personal information and respondent information shown in FIG. 7 are the same as the personal information and respondent information shown in FIG. 5, respectively. The response database shown in FIG. 7 includes the response file name storing the response data of the respondents, who responded to the questionnaire, as well as the user IDs of the users, who responded to the questionnaire, for each questionnaire file name. The personal information and respondent information are the information specified by the user ID.

Referring to FIG. 8, description will now be given on the questionnaire data, which is sent from computer 300 of the research agent to server 100. As shown in FIG. 8, the questionnaire data includes a header as well as the research agent ID and the questionnaire data. The questionnaire data includes information representing the contents of questionnairing conducted on the users.

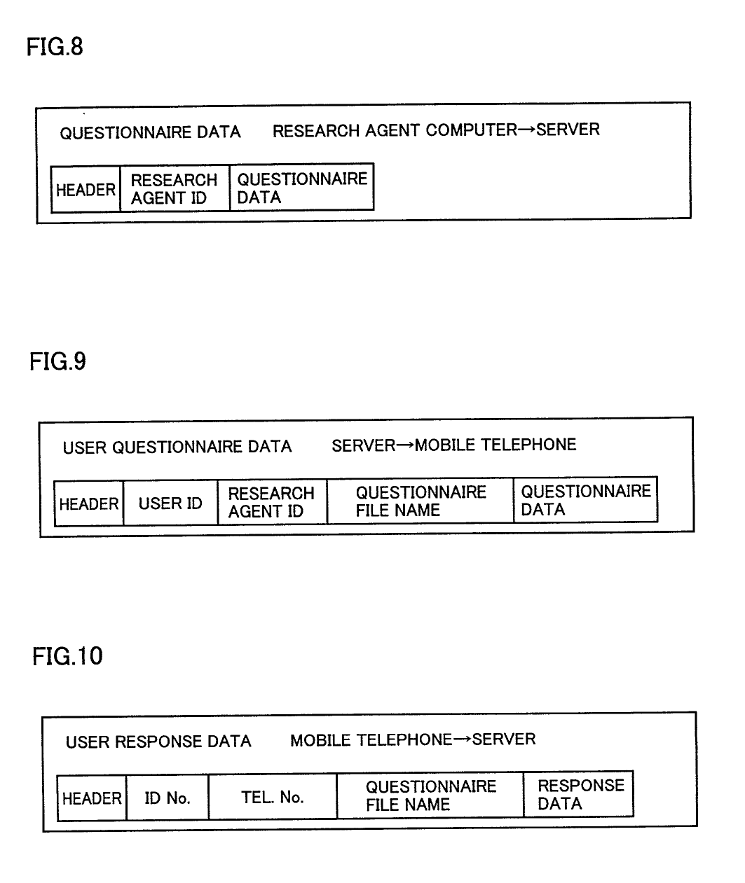

Referring to FIG. 9, description will now be given on the user questionnaire data sent from server 100 to mobile telephone 200. As shown in FIG. 9, the user questionnaire data includes a header as well as the user ID, research agent ID, questionnaire file name and questionnaire data. The research agent ID shown in FIGS. 8 and 9 is the research code applied from server 100 for specifying the research agent in the questionnairing system. The questionnaire file name shown in FIG. 9 is the identification code applied from server 100 for specifying the questionnairing conducted in this questionnairing system.

Referring to FIG. 10, description will now be given on the user response data sent from mobile telephone 200 to server 100. This user response data is sent to server 100 when the user of mobile telephone 200, which received the user questionnaire data, sends the answer to the questionnaire. As shown in FIG. 10, the user response data includes a header as well as the identification number, mobile telephone number, questionnaire file name and response data.

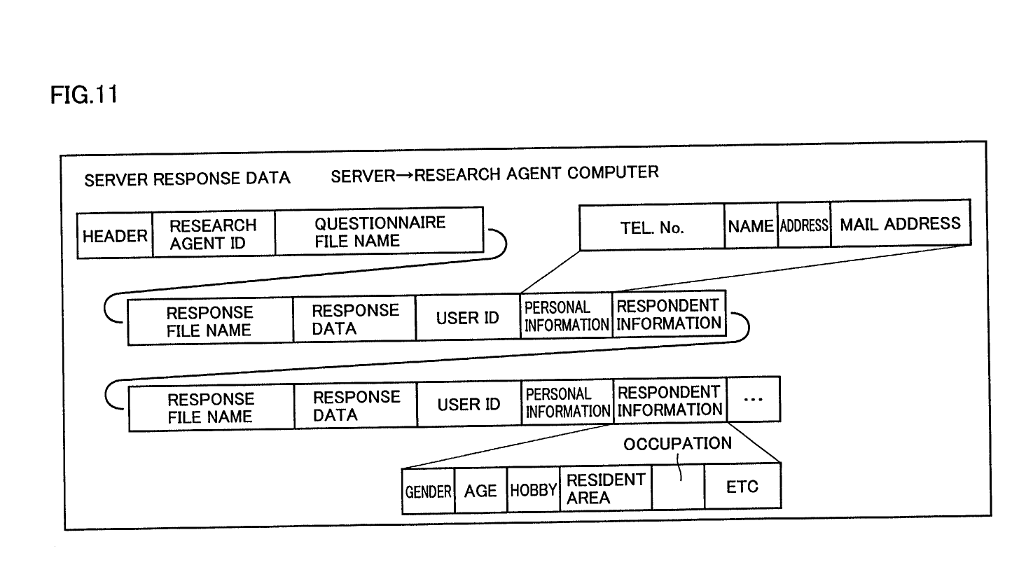

Referring to FIG. 11, description will now be given on the server response data sent from server 100 to research agent computer 300. As shown in FIG. 11, the server response data includes a header as well as the research agent ID, questionnaire file name and a plurality of response information pieces. The response information includes the response file name, response data, user ID, personal information and respondent information. The personal information includes the mobile telephone number, name, address and mail address. The respondent information includes the gender, age, hobby, resident area, occupation and other information. The personal information and respondent information shown in FIG. 11 are the same as the personal information and the respondent information shown in FIG. 7.

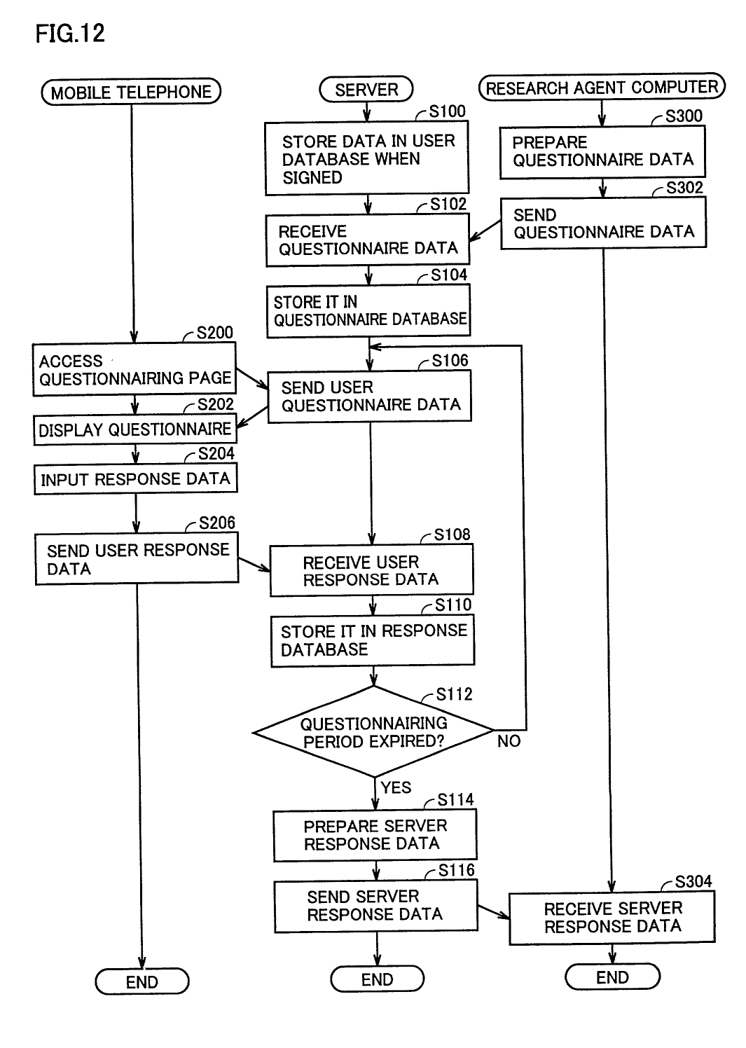

Referring to FIG. 12, the processing in the questionnairing system of this embodiment has the following control structure.

In step (which may also be expressed simply as “S” hereinafter) 100, server 100 stores data in the user database (FIG. 5) when the user signed a contract for the subscriber line. In S102, server 100 receives the questionnaire data (FIG. 8) from computer 300 of the research agent. In S104, server 100 stores the questionnaire data, which is received in S102, in the questionnaire database (FIG. 6).

In S106, server 100 sends the user questionnaire data (FIG. 9) to mobile telephone 200 when it detects the access to a questionnairing page from mobile telephone 200. Server 100 receives the user response data (FIG. 10) from mobile telephone 200. In S110, server 100 stores the user response data, which is received in S108, in the response database (FIG. 7).

In S112, server 100 determines whether a questionnairing period has expired. This questionnairing period is determined, in advance, to start after the questionnaire data is received in S102. When the questionnairing period has expired (YES in S112), the processing moves to a S114. If not (NO in S112), the processing returns to S106 for further receiving the user response data from another user.

In S114, server 100 prepares the server response data (FIG. 11). In this step, server 100 uses the personal information which is stored corresponding to the identification number. In S116, server 100 sends the server response data prepared in S114 to computer 300 of the research agent.

In S200, mobile telephone 200 accesses the questionnaire page displaying the questionnaire data on mobile telephone 200. In S202, mobile telephone 200 displays the questionnaire on display 254 based on the user questionnaire data (FIG. 9) received from server 100. In S204, mobile telephone 200 detects the response data entered by the user. In S206, mobile telephone 200 reads out the identification number from storage portion 240, and sends the user response data including the identification number (FIG. 10) to server 100.

In S300, computer 300 of the research agent prepares the questionnaire data. In S302, computer 300 of the research agent sends the questionnaire data (FIG. 8) to server 100. In S304, computer 300 of the research agent receives the server response data (FIG. 11) from server 100.

Description will now be given on the operation of the questionnairing system based on the structure and flowcharts described above.

When the user of mobile telephone 200 signed a contract for the subscriber line, the user database (FIG. 5) stores the name, address, gender, age, hobby, resident area, occupation and others of the user (S100).

The research agent prepares the questionnaire data (FIG. 8) by using computer 300 of the research agent (S300), and sends it to server 100 (S302).

When server 100 has received the questionnaire data shown in FIG. 8 (S102), it stores the received questionnaire data in the questionnaire database shown in FIG. 6 (S104).

When the user of mobile telephone 200 accesses the questionnairing page (S200), server 100 sends the user questionnaire data (FIG. 9) to mobile telephone 200 (S106). Mobile telephone 200 displays the questionnaire data on display 254 based on the received user questionnaire data (FIG. 9). The user of mobile telephone 200 enters the answer to questionnaire displayed on display 254 (S204). Mobile telephone 200 reads out the identification number from storage portion 240. The user response data (FIG. 10), which includes the response data and the identification number, is sent to server 100 (S206).

When server 100 has received the user response data (FIG. 10) from mobile telephone 200 (S108), it stores the received user response data in the response database shown in FIG. 7 (S10). When the questionnairing period expires (YES in S112), server 100 prepares the server response data shown in FIG. 11 (S114). The server response data includes the personal information and respondent information. Server 100 sends the server response data prepared thereby to computer 300 of the research agent.

Computer 300 of the research agent has received the server response data from server 100 (S304). The research agent compiles the results of questionnairing based on the server response data (FIG. 11) received by computer 300 of the research agent. In this operation, the answers to the questionnaire are compiled based on the respondent information.

In the manner described above, the questionnairing system according to the embodiment stores the personal information and the respondent information in the user database of the server when the user signed a contract for the subscriber line with the communication company of the mobile telephone. The questionnaire data sent from the research agent to the server is sent to the mobile telephone in response to the request of the user of mobile telephone. The user of mobile telephone is not required to enter the personal information such as user's name and address into the mobile telephone, and the identification number for identifying the hardware of mobile telephone is automatically sent to the server. Based on this identification number, the personal information of the user and the respondent information retrieved in the server are sent to the research agent together with the answer to the questionnaire. As a result, it is possible to achieve the questionnairing system, in which the respondent to the questionnaire can easily respond to the questionnairing.

First Modification of First Embodiment

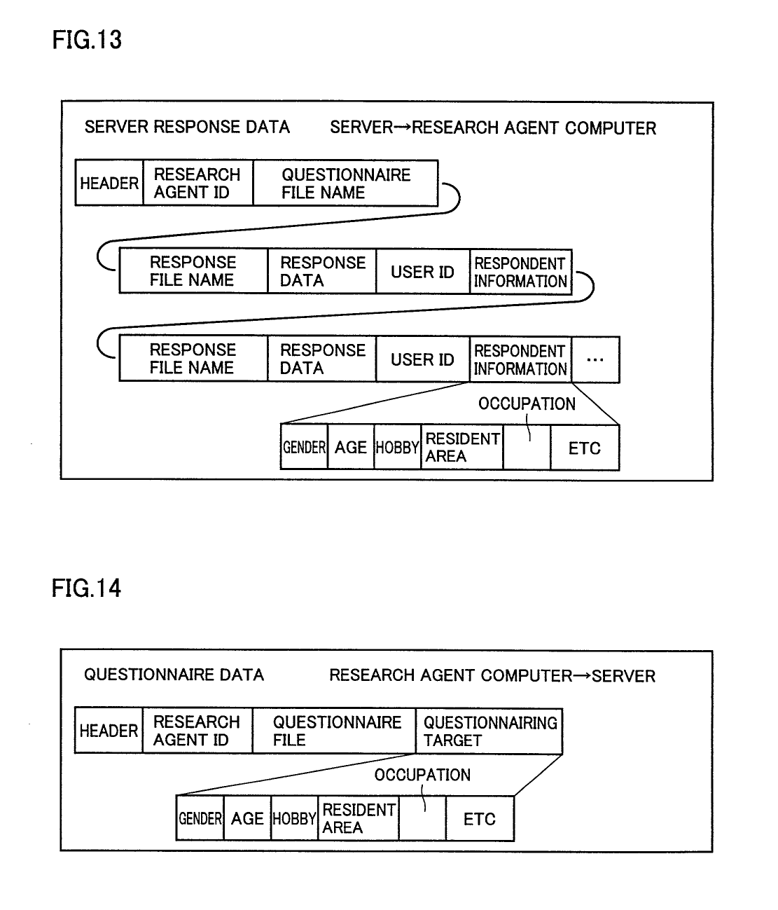

Referring to FIG. 13, a first modification of the first embodiment will now be described. The first modification differs from the first embodiment in that server response data shown in FIG. 13 is employed instead of the server response data shown in FIG. 11. Structures and flowcharts other than it are the same as those of the first embodiment already described, and therefore, description thereof is not repeated here.

Referring to FIG. 13, the server response data according to the modification includes the header, research agent ID, questionnaire file name and response information. The response information includes the response file name, response data, user ID and respondent information. The server response data shown in FIG. 13 does not include the personal information, which is a difference from the server response data in FIG. 11. The server response data sent to computer 300 of the research agent does not include the personal information such as user's name and address, of which security is strongly required for privacy protection. Accordingly, the research agent cannot determine the personal information of the user. Thereby, it is possible to achieve the questionnairing system, which allows easy responding to the questionnaire while protecting the privacy of the respondent.

Second Modification of First Embodiment

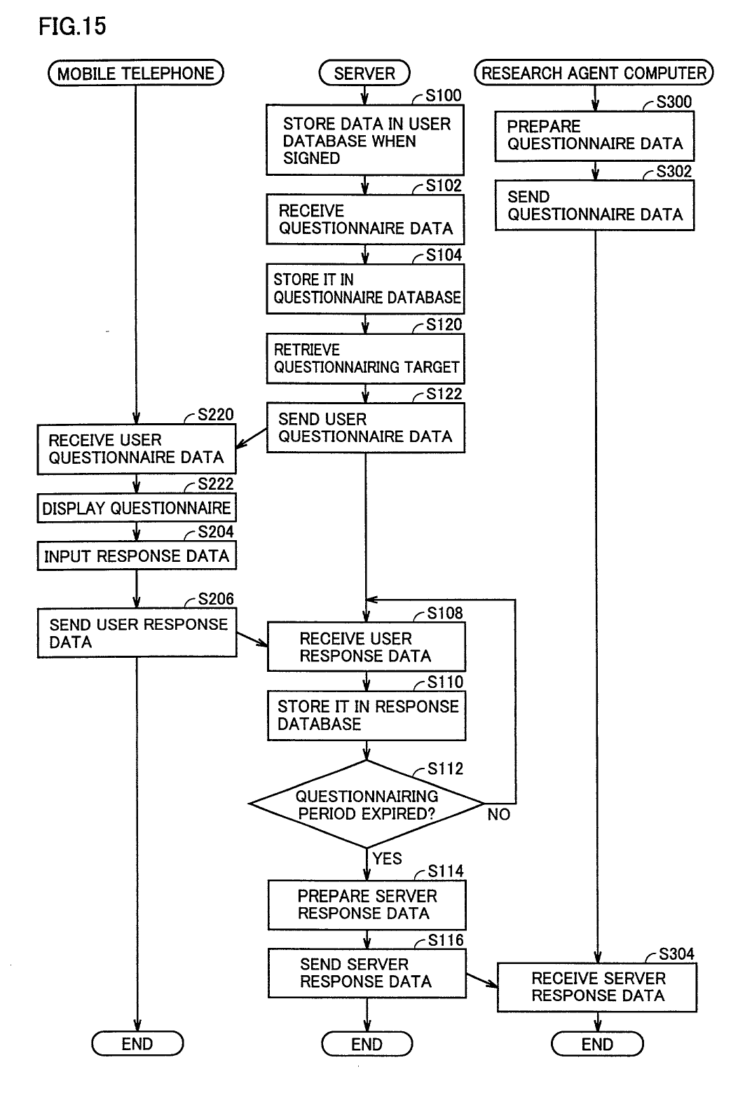

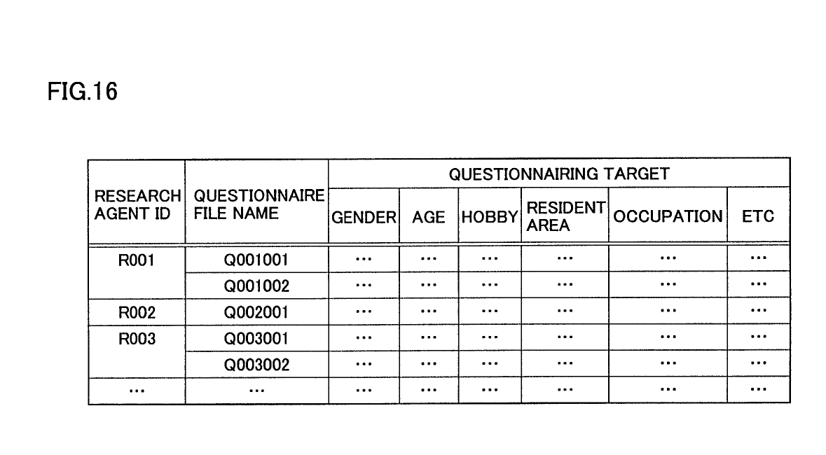

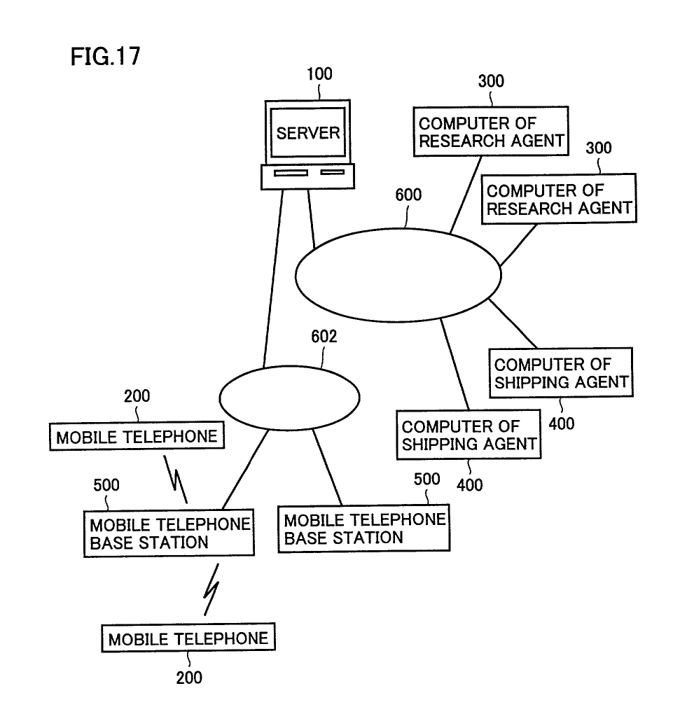

Referring to FIGS. 14-16, a second modification of the first embodiment will now be described. Similarly to the first modification, the second modification employs the same structures and flowcharts except for the questionnaire data shown in FIG. 14, the flowchart of FIG. 15 and questionnaire database shown in FIG. 16. Therefore, description of the same structures and flowcharts is not repeated here.

Referring to FIG. 14, the questionnaire data of this modification includes the header, research agent ID, questionnaire file and questionnairing target. The questionnairing target includes information relating to the gender, age, hobby, resident area, occupation and others. The questionnaire data shown in FIG. 14 includes the data representing the questionnairing target in addition to the questionnaire data shown in FIG. 8.

Referring to FIG. 15, the processing of the questionnairing system according to this modification has the following control structure. In the flowchart shown in FIG. 15, the steps for performing the same processing as those in the flowchart of FIG. 12 bear the same step numbers, and therefore description thereof is not repeated here.

In S300, computer 300 of the research agent prepares the questionnaire data (FIG. 14). In S302, computer 300 of the research agent sends the questionnaire data (FIG. 14) prepared in S300 to server 100.

In S104, server 100 stores the questionnaire data (FIG. 14) received from computer 300 of the research agent in questionnaire database (FIG. 16). The questionnaire database shown in FIG. 16 includes the questionnairing target in addition to the questionnaire database shown in FIG. 6. In S120, server 100 retrieves the users having the respondent information, which matches with the questionnairing target stored in the questionnaire database. In S122, server 100 sends the user questionnaire data (FIG. 9) to the retrieved users.

In S220, mobile telephone 200 receives the user questionnaire data (FIG. 9) from server 100. In S222, mobile telephone 200 displays the questionnaire on display 254 based on the user questionnaire data received in S220.

According to the questionnairing system of this modification, as described above, the research agent can narrow the range of the questionnairing targets based on the user database stored in the server. As a result, the research agent can conduct the questionnairing on the users in the aimed range.

As shown in FIGS. 12-15, server 100 keeps the response data obtained from the user until the end of the questionnairing period, and thereafter collectively sends the response data to computer 300 of the research agent, although not restricted to this manner. Server 100 may be configured to send the response data to computer 300 of the research agent every time it receives the response data.

Second Embodiment

A questionnairing system according to a second embodiment of the invention includes a computer 400 of a shipping agent connected to a network in addition to the same structures as those in the questionnairing system of the first embodiment, as shown in FIG. 17. The shipping agent uses computer 400 for delivering a prize to the user, which is selected by lottery from the questionnaire respondents.

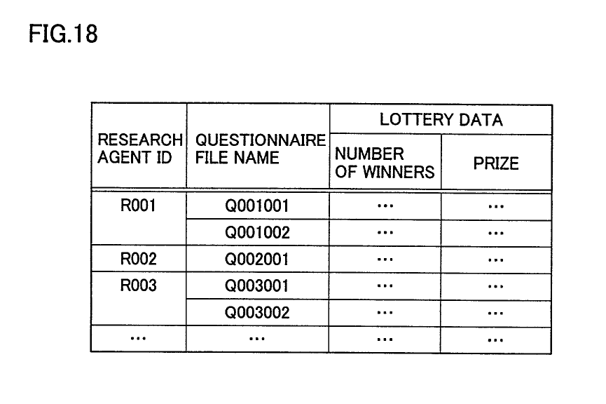

Referring to FIG. 18, description will now be given on the questionnaire database stored on fixed disk 124 of server 100. As shown in FIG. 18, the questionnaire database includes the questionnaire file name and lottery data for each research agent ID. The lottery data includes the number of winner(s) and the prizes. The questionnaire database shown in FIG. 18 includes the lottery data in addition to the questionnaire database shown in FIG. 6.

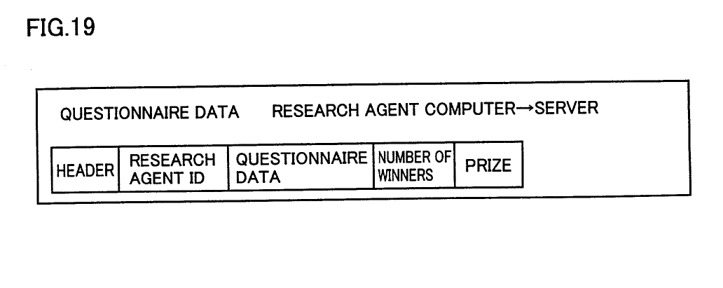

Referring to FIG. 19, description will now be given on the questionnaire data sent from computer 300 of the research agent to server 100 in this embodiment. As shown in FIG. 19, the questionnaire data includes a header as well as the research agent ID, questionnaire data, number of winners and data representing the prize(s). The number of winners is the number of persons, to which the prize(s) are to be awarded by lottery.

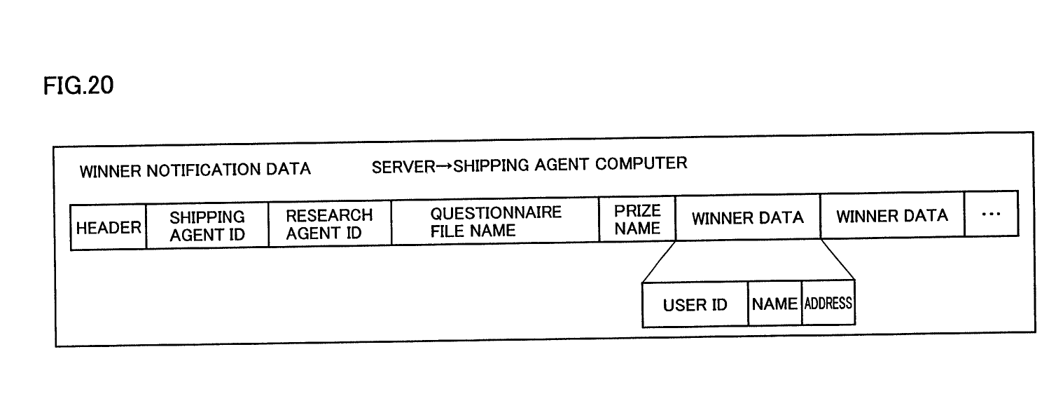

Referring to FIG. 20, description will now be given on winner notification data, which is sent from server 100 to computer 400 of the shipping agent in this embodiment. As shown in FIG. 20, the winner notification data includes a header as well as the shipping agent ID, research agent ID, questionnaire file name, prize name and a plurality of winner data pieces. The winner data includes the user ID, name and address. The shipping agent ID is an identification code, which is applied by server 100 for specifying the shipping agent delivering the prize to the winner in the above questionnairing system.

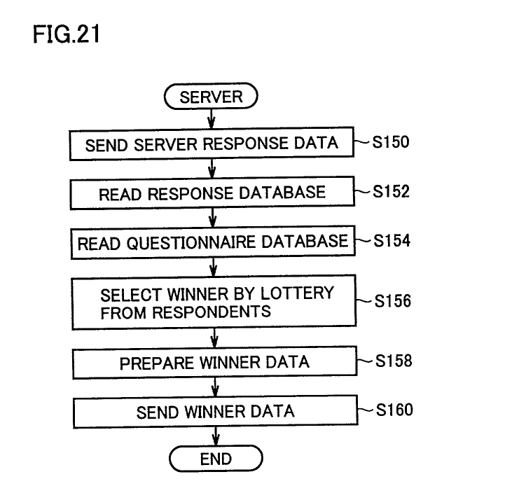

Referring to FIG. 21, the processing by server 100 according to this embodiment has the following structure.

In S150, server 100 sends the server response data (FIG. 11 or 13) to computer 300 of the research agent. In S152, server 100 reads out the response database (FIG. 7). In S154, server 100 reads out the questionnaire database (FIG. 18). In S156, server 100 refers to the response database (FIG. 7) to select the winner from the respondents.

In S158, server 100 prepares the winner notification data (FIG. 20). In S160, server 100 sends the winner notification data thus prepared to computer 400 of the shipping agent.

According to the questionnairing system in this embodiment, the server selects by lottery the winners equal in number to the value designated by the research agent from the respondents. The name and address of each winner are sent to the computer of shipping agent, and the shipping agent delivers the prize to each winner. The user expects to get the prize, and responds to the questionnaire or the like. As a result, it is possible to achieve the questionnairing system, which can increase the rate of response to the questionnaire.

Modification of Second Embodiment

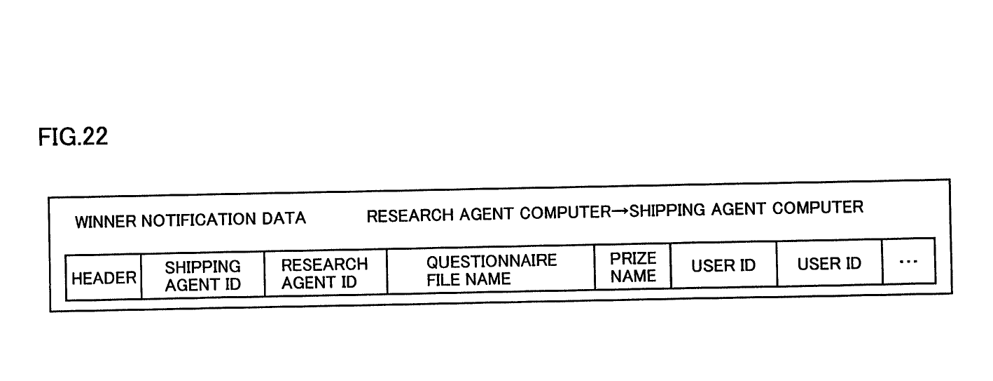

Referring to FIGS. 22-25, description will now be given on a modification of the second embodiment. In this modification, the lottery processing, which is executed by server 100 in the second embodiment described above, is executed by computer 300 of the research agent. The structures and flowcharts other than those, which will be described below, are the same as the foregoing structures and flowcharts of the second embodiment, and-therefore, description thereof is not repeated here.

Referring to FIG. 22, description will now be given on the winner notification data, which is sent from computer 300 of the research agent to computer 400 of the shipping agent in this modification. As shown in FIG. 22, the winner notification data includes a header as well as the shipping agent ID, research agent ID, questionnaire file name, prize name and a plurality of user IDs. The winner notification data shown in FIG. 22 is different from the foregoing winner notification data shown in FIG. 20 in that the user ID is included instead of the winner data including the name and address of the user. The user ID shown in FIG. 22 is the identification of the winner selected by the lottery based on the user IDs, which are included in the server response data (FIG. 13) received by computer 300 of the research agent from server 100.

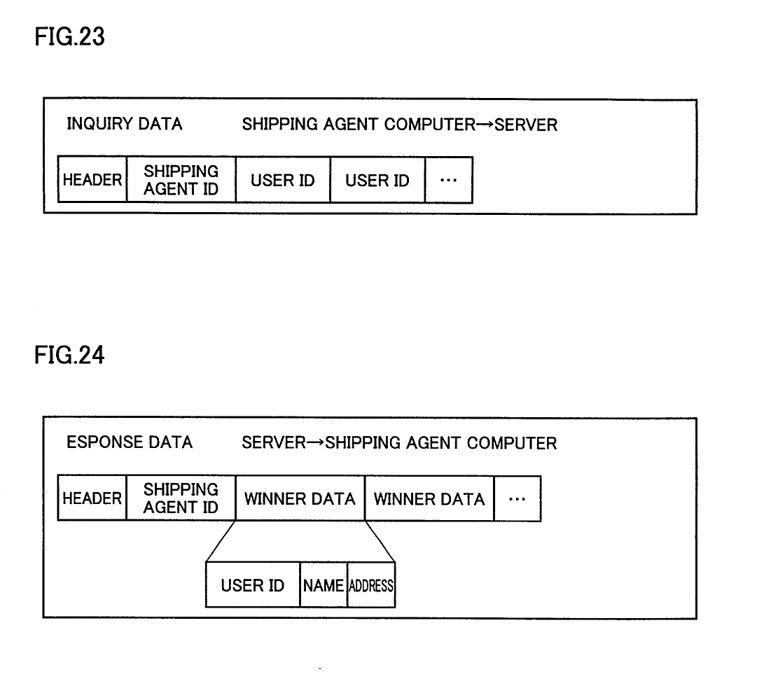

Referring to FIG. 23, description will now be given on an inquiry data sent from computer 400 of the shipping agent to server 100 in the modification. As shown in FIG. 23, the inquiry data includes a header as well as the shipping agent ID and a plurality of user IDs. The inquiry data shown in FIG. 23 is the data to be sent to server 100 from computer 400 of the shipping agent, which received the winner notification data shown in FIG. 22.

Referring to FIG. 24, description will now be given on the response data sent from server 100 to computer 400 of the shipping agent in this modification. As shown in FIG. 24, the response data includes a header as well as the shipping agent ID and data representing the plurality of winners. The winner data includes the user IDs, names and addresses. Server 100, which has received the inquiry data shown in FIG. 23, sends the response data (FIG. 24) to computer 400 of the shipping agent.

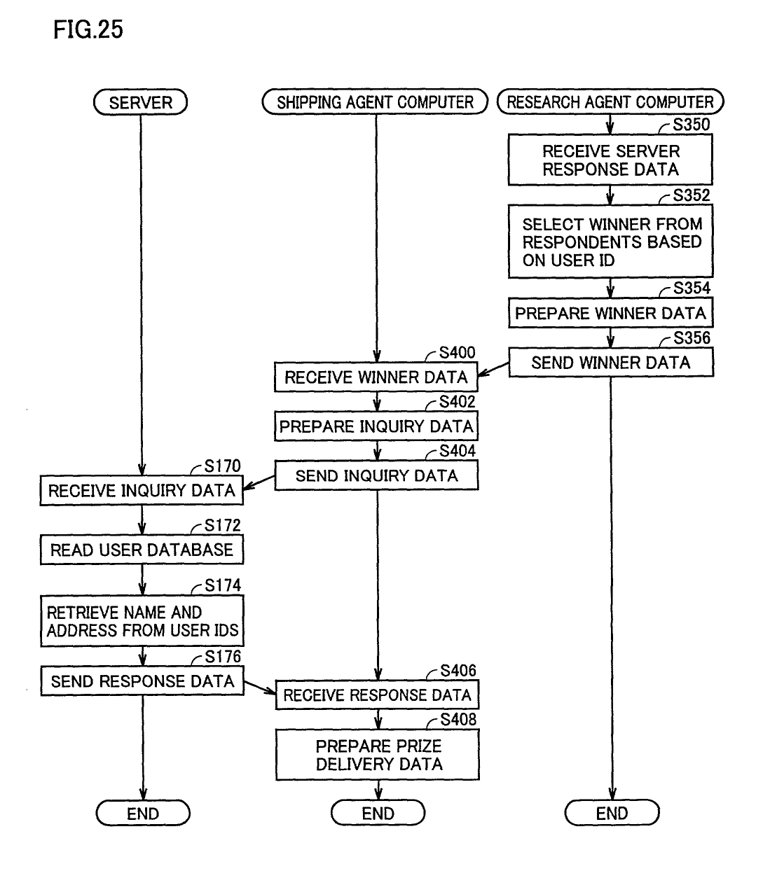

Referring to FIG. 25, the processing executed in the questionnairing system according to this modification has the following control structure.

In S350, computer 300 of the research agent receives the server response data (FIG. 13) from server 100. In S352, computer 300 of the research agent selects the winners from the respondents based on the user IDs in the received server response data. In S354, computer 300 of the research agent prepares the winner notification data (FIG. 22). In S356, computer 300 of the research agent sends the winner data prepared in S354 to computer 400 of the shipping agent.

In S400, computer 400 of the shipping agent receives the winner data from computer 300 of the research agent. In S402, computer 400 of the shipping agent prepares the inquiry data (FIG. 23). In S404, computer 400 of the shipping agent sends the inquiry data prepared in S402 to server 100.

In S406, computer 400 of the shipping agent receives response data (FIG. 24) from server 100. In S408, computer 400 of the shipping agent prepares the prize delivery data based on the name and address of the user included in the response data, which is received in S406.

In S170, server 100 receives the inquiry data (FIG. 23) from computer 400 of the shipping agent. In S172, server 100 reads out the user database (FIG. 5). In S174, server 100 retrieves the names and addresses of the users of the user IDs, which are included in the inquiry data, based on the user IDs included in the received inquiry data and the user database. In S176, server 100 sends the response data (FIG. 24) to computer 400 of the shipping agent.

According to the questionnairing system of this modification, the personal information such as user's name and address requiring high security for privacy protection is not sent to the research agent, and the drawing of lots is performed based on the user IDs, from which the research agent cannot determine the name and address. As a result of lottery, the user IDs are sent to the computer of the shipping agent, and the computer of the shipping agent makes an inquiry based on the user IDs to the server. The server sends the name and address of each user ID, about which the inquiry is made, to the shipping agent. The user expects to get the prize, and responds to the questionnaire or the like. As a result, it is possible to achieve the questionnairing system, which can improve the rate of response to the questionnairing while protecting the privacy.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An apparatus for mediating collection of users in accordance with a request of a requester of the collection, comprising:
a communication circuit for communicating with terminals via a network;
a storage circuit for storing, in advance, collection information representing said collection;
a collection sending circuit connected to said communication circuit and said storage circuit for sending said collection information to terminals of said users, said user's terminal storing unrewritable identification information for specifying the terminal itself of the user, and said user's terminal reading out said identification information, and sending said application information and said identification information to said apparatus when the user enters the application information for applying for said collection into said user's terminal;
a user information storage circuit for storing, in advance, said identification information and user information corresponding to said identification information;
an application receiving circuit connected to said communication circuit for receiving said application information and said identification information from said user's terminals;
a retrieval circuit connected to said application receiving circuit and said user information storage circuit for retrieving the user information stored corresponding to said received identification information; and
an application sending circuit connected to said communication circuit and said retrieval circuit for sending the user information retrieved by said retrieval circuit and said application information to said terminal of the requester.

2. The apparatus according to claim 1, further comprising:
a collection target receiving circuit connected to said communication circuit for receiving information representing the collection target users determined corresponding to said user information from said terminal of the requester; and
a collection target retrieval circuit connected to said user's information storage circuit and said collection target receiving circuit for retrieving the users matching with said collection target users based on the information representing said collection target users and said user information, wherein
said collection sending circuit includes a circuit for sending said collection information to the terminal of the user retrieved by said collection target retrieval circuit.

3. The apparatus according to claim 1, wherein
said user information includes personal information representing a name and an address of the user, and
said application sending circuit includes a circuit for sending said user information to said terminal of the requester in a manner preventing determination of said personal information by said requester.

4. The apparatus according to claim 3, further comprising:
a lottery circuit for selecting a winner from the applicants based on said user information; and
a personal information sending circuit connected to said communication circuit and said lottery circuit for sending said personal information of said winner to a terminal of a shipping agent delivering a prize to said winner so as to allow determination of said personal information by said shipping agent.

5. The apparatus according to claim 3, wherein
said terminal of the requester selects a winner from the applicants based on said user information, and sends the user information of the winner to a terminal of a shipping agent delivering a prize to said winner, said shipping agent cannot determine the personal information of said winner based on the received user information, said terminal of the shipping agent makes an inquiry to said apparatus about the personal information of said winner based on the user information of said winner received from said terminal of the requester, and said apparatus further comprises:
an inquiry receiving circuit connected to said communication circuit for receiving the user information of said winner from said terminal of the shipping agent; and
a personal information sending circuit connected to said communication circuit for sending the personal information of said winner to said terminal of the shipping agent so as to allow determination of said personal information by said shipping agent.

6. An apparatus for mediating collection of users in accordance with a request of a requester of the collection, comprising:
communication means for communicating with terminals via a network;
storage means for storing, in advance, collection information representing said collection;
collection sending means connected to said communication means and said storage means for sending said collection information to terminals of said users, said user's terminal storing unrewritable identification information for specifying the terminal itself of the user, and said user's terminal reading out said identification information, and sending said application information and said identification information to said apparatus when the user enters the application information for applying for said collection into said user's terminal;
user information storage means for storing, in advance, said identification information and user information corresponding to said identification information;
application receiving means connected to said communication means for receiving said application information and said identification information from said user's terminals;
retrieval means connected to said application receiving means and said user information storage means for retrieving the user information stored corresponding to said received identification information; and
application sending means connected to said communication means and said retrieval means for sending the user information retrieved by said retrieval means and said application information to said terminal of the requester.

7. The apparatus according to claim 6, further comprising:
collection target receiving means connected to said communication means for receiving information representing the collection target users determined corresponding to said user information from said terminal of the requester; and
collection target retrieval means connected to said user's information storage means and said collection target receiving means for retrieving the users matching with said collection target users based on the information representing said collection target users and said user information, wherein
said collection sending means includes means for sending said collection information to the terminal of the user retrieved by said collection target retrieval means.

8. The apparatus according to claim 6, wherein
said user information includes personal information representing a name and an address of the user, and
said application sending means includes means for sending said user information to said terminal of the requester in a manner preventing determination of said personal information by said requester.

9. The collection mediating apparatus according to claim 8, further comprising:
lottery means for selecting a winner from the applicants based on said user information; and
personal information sending means connected to said communication means and said lottery means for sending said personal information of said winner to a terminal of a shipping agent delivering a prize to said winner so as to allow determination of said personal information by said shipping agent.

10. The apparatus according to claim 8, wherein
said terminal of the requester selects a winner from the applicants based on said user information, and sends the user information of the winner to a terminal of a shipping agent delivering a prize to said winner, said shipping agent cannot determine the personal information of said winner based on the received user information, said terminal of the shipping agent makes an inquiry to said apparatus about the personal information of said winner based on the user information of said winner received from said terminal of the requester, and said collection mediating apparatus further comprises:
inquiry receiving means connected to said communication means for receiving the user information of said winner from said terminal of the shipping agent; and
personal information sending means connected to said communication means for sending the personal information of said winner to said terminal of the shipping agent so as to allow determination of said personal information by said shipping agent.

11. A method for mediating collection of users in accordance with a request of a requester of the collection, comprising the steps of:
preparing collection information representing said collection;
sending said collection information to terminals of said users,
said user's terminal storing unrewritable identification information for specifying the terminal itself of the user, and said user's terminal reading out said identification information, and sending said application information and said identification information when the user enters the application information for applying for said collection into said user's terminal;
preparing identification information and user information corresponding to said identification information;
receiving said application information and said identification information from said user's terminal;
retrieving the user information stored corresponding to said received identification information; and
sending the user information retrieved in said step of retrieving the user information and said application information to a terminal of said requester.

12. The method according to claim 11, further comprising the steps of:
receiving information representing the collection target users determined corresponding to said user information from said terminal of the requester; and
retrieving the users matching with said collection target users based on the information representing said collection target users and said user information, wherein
said step of sending the collection information includes the step of sending said collection information to the terminal of the user retrieved in said step of retrieving said user.

13. The method according to claim 11, wherein
said user information includes personal information representing a name and an address of the user, and
said step of sending said user information and said application information includes the step of sending said user information to said terminal of the requester in a manner preventing determination of said personal information by said requester.

14. The method according to claim 13, further comprising the steps of:
selecting a winner from the applicants based on said user information; and
sending said personal information of said winner to a terminal of a shipping agent delivering a prize to said winner so as to allow determination of said personal information by said shipping agent.

15. The method according to claim 13, wherein
said terminal of the requester selects a winner from the applicants based on said user information, and sends the user information of the winner to a terminal of a shipping agent delivering a prize to said winner, said shipping agent cannot determine the personal information of said winner based on the received user information, said terminal of the shipping agent makes an inquiry about the personal information of said winner based on the user information of said winner received from said terminal of the requester, and said collection mediating method further comprises the steps of:
receiving the user information of said winner from said terminal of the shipping agent; and
sending the personal information of said winner to said terminal of the shipping agent so as to allow determination of said personal information by said shipping agent.
